(19) United States
(12) Patent Application Publication
(10) Pub. No.: US 2006/0096036 A1
(43) Pub. Date: May 11, 2006

(54) Method for hydrophobing leather and furskins

(76) Inventors: Ralph Lunkwitz, Neustadt (DE); Peter Danisch, Ludwigshafen (DE); Thorsten Radler, Ludwigshafen (DE); Werner Janson, Bad Durkheim (DE); Friedrich Sattler, Monzernheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/544,785

(22) PCT Filed: Jan. 28, 2004
(86) PCT No.: PCT/EP04/00706

§ 371 Date: Aug. 8, 2005

(30) Foreign Application Priority Data
Feb. 17, 2003 (DE) 103 06 748.5
Jul. 18, 2003 (DE) 103 32 991.9

(51) Int. Cl. C14C 1/00

(52) U.S. Cl. 8/94.15

(57) ABSTRACT

Water repellency is imparted to leather and fur skins by a process in which leather or fur skin is treated, before, during or after the retanning, with one or more formulations comprising from 1 to 30% by weight, based on the formulation, of a mixture of polysiloxanes comprising from 10 to 90% by weight, based on the mixture, of one or more carboxyl-containing polysiloxanes, from 90 to 10% by weight, based on the mixture, of one or more carboxyl-free polysiloxanes and from 3 to 25% by weight, based on the formulation, of at least one emulsifier.

The present invention relates to a process for imparting water repellency to leather and fur skins, wherein leather or fur skin is treated, before, during or after the retanning, with one or more formulations comprising from 1 to 30% by weight, based on the formulation, of a mixture of polysiloxanes comprising

from 10 to 90% by weight, based on the mixture, of one or more carboxyl-containing polysiloxanes,

from 90 to 10% by weight, based on the mixture, of one or more carboxyl-free polysiloxanes

and from 3 to 25% by weight, based on the formulation, of at least one emulsifier.

EP 0 213 480 B discloses a process for imparting water repellency to leather and fur skins, in which an aqueous emulsion of a silicone oil or an anhydrous mixture of a silicone oil and an alkanolamine salt of an amino acid is allowed to act on leather or skins before, during or after the retanning. Examples of polysiloxanes are: dimethylpolysiloxane in which 3% of the methyl groups have been replaced by mercaptopropyl (examples 1 to 7), dimethylpolysiloxane having a viscosity from 80 to 110 mPa·s, phenylmethylpolysiloxanes having a viscosity from 85 to 120 mPa·s and dimethylpolysiloxanes having on average from 2 to 10 carboxyl groups per molecule. The performance characteristics of such water repellent formulations can however still be improved. Furthermore, the leathers produced with the aid of the polysiloxanes disclosed can in some cases also be improved with regard to performance characteristics.

WO 95/22627 discloses a process for imparting water repellency to leather and fur skins using carboxyl-containing polysiloxanes in aqueous emulsion, in which polysiloxanes which are branched in a comb-like manner and may have the formula A are used: 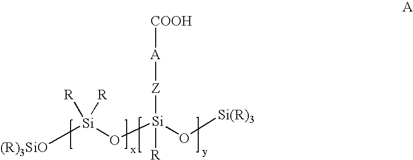
The structural units may, for example, be randomly distributed. The variables are defined as follows:
R are identical or different and, independently of one another, are hydrogen, hydroxyl, C₁-C₄-alkyl, phenyl, C₁-C₄-alkoxy, amino, mono- or di-C₁-C₄-amino, chlorine or fluorine, it also being possible in each case for a radical R to be the group Z-A-COOH at the chain ends;
A is a linear or branched C₅-C₂₅-alkylene group and
Z is a direct bond, an oxygen atom or an amino, carbonyl, amido or ester group.

On average, preferably from 2.5 to 15 carboxyl groups are present per molecule (page 4, line 17).

Leather and fur skin treated with the aid of such comb-like polysiloxanes generally have very good water repellency.

WO 98/04748 discloses a process for retanning leathers produced using polymeric tanning agents and, if required, aldehyde tanning agents, which leathers are treated with polymer tanning agents and with comb-like polysiloxanes of the formula A defined above.

EP-A 1 087 021 discloses that leather treatment compositions comprising a combination of polysiloxanes substituted by carboxyl or carboxylic anhydride groups at the α,ω-position, the carboxyl groups of the polysiloxane being present in neutralized form, with certain amphiphilic polymers, an emulsifier and an oil or wax are suitable as leather treatment compositions. With the aid of the combination products disclosed, full and soft leathers which were readily washable were produced.

However, it is observed that leather and fur skin obtained according to the publications cited above have in many cases a dyeing with an undesirably low degree of levelness. Moreover, the high price of the polysiloxanes branched in a comb-like manner is to be regarded as disadvantageous.

It is an object of the present invention to provide a process for the production of leather and fur skins which does not have the abovementioned disadvantages. It is further-more an object of the present invention to provide leather having advantageous performance characteristics.

It is moreover an object of the present invention to provide novel formulations having advantageous performance characteristics.

We have found that this object is achieved by the process defined at the outset. According to the invention, leather is treated with a formulation before, during or after the retanning.

At least one formulation used in the novel process comprises from 1 to 30, preferably from 5 to 20, particularly preferably from 7 to 12.5, % by weight, based on the weight of the formulation, of a mixture of two or more polysiloxanes.

From 10 to 90% by weight, based on the mixture, of the polysiloxanes comprised in at least one formulation are carboxyl-containing polysiloxanes.

In an embodiment, carboxyl-containing polysiloxanes are those which contain the structural elements of the formulae I and II and optionally structural elements III a and/or III b.

The structural elements defined above are each arranged in such a way that Si—O—Si—O chains are formed. Formation of Si—Si groups is theoretically possible but plays a minor role in most cases.

In the formulae I, II, III a and III b, the variables are defined as follows:

R¹ are identical or different and, independently of one another, are hydrogen,

hydroxyl,

C₁-C₄-alkyl, such as methyl, ethyl, n-propyl, isopropyl, n-butyl, isobutyl, sec-butyl and tert-butyl; in particular methyl;

C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl;

C₁-C₄-alkoxy, such as methoxy, ethoxy, n-propoxy, isopropoxy, n-butoxy, isobutoxy, sec-butoxy and tert-butoxy;

amino,

mono-C₁-C₄-alkylamino, for example —NHCH₃, —NHC₂H₅, —NH(CH₂)₂CH₃, —NH(CH₂)₃CH₃, —NH—CH(CH₃)₂, NHC(CH₃)₃;

di-C₁-C₄-alkylamino, —N(CH₃)₂, —N(C₂H₅)₂, —N(CH₃)(C₂H₅), —N[(CH₂)₂CH₃]₂, —N(CH₃)CH(CH₃)₂,

or Z¹-A¹—COOH.

In a preferred embodiment of the present invention, all R¹ are identical and are each methyl.

In another preferred embodiment, the structural elements I are identical in each case, in I in each case one R¹ being methyl and the other R¹ being phenyl.

In an embodiment of the present invention, the structural elements of the formula III a are selected from the following groups: Si(CH₃)₃, Si(CH₃)₂C₆H₅, Si(CH₃)₂OH, Si(CH₃)C₆H₅OH.

A¹ are identical or different and are linear or branched C₅-C₂₅-alkylene, unsubstituted or substituted by one or more C₁-C₄-alkyl or phenyl, for example

—(CH₂)₅—, —(CH₂)₆—, —(CH₂)₈, —(CH₂)₈—, —(CH₂)₉—, —(CH₂)₁₀—, —(CH₂)₁₁—, —(CH₂)₁₂—, —(CH₂)₁₃—, —(CH₂)₁₄—, —CH(CH₃)—CH₂—CH₂—CH₂—CH(CH₃)—, —C(CH₃)₂—CH₂—CH₂—CH₂—CH(CH₃)—;

—CH(C₆H₅)—CH₂—CH₂—CH₂—CH(CH₃)—; preferably —(CH₂)₈—, —(CH₂)₉—, —(CH₂)₁₀—, —(CH₂)₁₁—, —(CH₂)₁₂—;

it being possible for C₅-C₂₅-alkylene to be interrupted by 1 to 8 oxygen atoms not directly bonded to one another.

Z¹ is

a direct bond,

oxygen

an amino group of the formula —NR²

a carbonyl group,

an amido group of the formula —NR²—CO— or —CO—NR²— or

an ester group of the formula CO—O or O—CO;

R² are identical or different and, independently of one another, are selected from hydrogen,

C₁-C₄-alkyl, such as methyl, ethyl, n-propyl, isopropyl, n-butyl, isobutyl, sec-butyl and tert-butyl.

Polysiloxanes which comprise the structural elements of the formulae I, II and optionally III a and/or III b may be linear or have a cyclic or branched structure. Branched polysiloxanes which comprise the structural elements I, II and optionally III a and/or III b generally additionally comprise structural elements, for example of the formula IV a or IV b 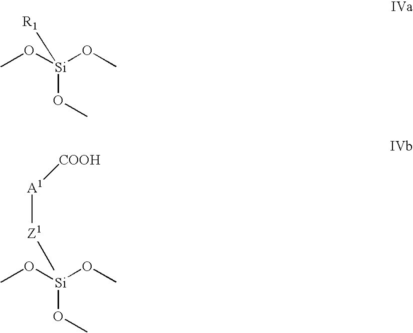
in which the variables are defined as above. Cyclic straight-chain polysiloxanes which comprise the structural elements of the formula I or II usually comprise no structural elements of the formulae III a and III b.

The structural elements I, II and optionally IV a and IV b can be distributed alternately, blockwise and preferably randomly in carboxyl-containing polysiloxane molecules.

In an embodiment of the present invention, carboxyl-comprising polysiloxanes contain from 1 to 50, preferably from 2 to 25, particularly preferably from 2.5 to 15, carboxyl groups per molecule.

Usually, the molecular weight M_{w} of the carboxyl-containing polysiloxanes used according to the invention and having the structural elements I, II, optionally III a, III b, IV a and IV b is from 5 000 to 150 000, preferably from 10 000 to 100 000, g/mol.

The molecular weight determination can be carried out by methods known to a person skilled in the art, for example by light scattering methods or viscosity determinations.

In an embodiment of the present invention, all or at least a certain proportion, for example a third or a half, of the carboxyl groups in the carboxyl-containing poly-siloxanes are neutralized. For example, basic salts, such as hydroxides or carbonates of the alkali metals, for example Na or K, are suitable for the neutralization. Ammonia, alkylamines, such as methylamine, dimethylamine, trimethylamine, ethylamine, diethylamine, triethylamine and ethylenediamine, and alkanolamines, such as ethanolamine, diethanolamine, triethanolamine, N-methylethanolamine, N-methyl-diethanolamine or N-(n-butyl)diethanolamine, are furthermore suitable.

The mixtures used according to the invention comprise, for example, from 10 to 90, preferably from 40 to 60, particularly preferably about 50, % by weight, of carboxyl-containing polysiloxane.

The mixtures used according to the invention furthermore comprise polysiloxanes which comprise no carboxyl groups. Such polysiloxanes generally comprise structural units of the above-defined formulae I, optionally III a, III b and IV a, the variables being defined as above, but R¹ is not Z¹-A¹—COOH. Carboxyl-free polysiloxanes used according to the invention are preferably composed of structural elements of the above-defined formulae I, optionally III a, III b and IV a.

Particularly preferably used carboxyl-free polysiloxanes are poly(dimethyl)siloxanes and poly(phenylmethyl)siloxanes.

Carboxyl-free polysiloxanes which comprise the structural elements of the formulae I and optionally III a, III b and IV a may have a linear or cyclic or branched structure. Branched carboxyl-free polysiloxanes which comprise the structural elements I and optionally III a and/or III b generally additionally comprise structural elements, for example of the formula IV a. Cyclic straight-chain carboxyl-free polysiloxanes which comprise the structural elements of the formula I usually comprise no structural elements of the formulae III a and III b.

In a preferred embodiment of the present invention, all R¹ in carboxyl-free polysiloxanes are identical and are each methyl.

In another preferred embodiment, the structural elements I in carboxyl-free polysiloxanes are in each case identical, in I in each case one R¹ being methyl and the other R¹ being phenyl.

In an embodiment of the present invention, the structural elements of the formula III a in carboxyl-free polysiloxanes are selected from the following groups: Si(CH₃)₃, Si(CH₃)₂C₆H₅, Si(CH₃)₂OH, Si(CH₃)C₆H₅OH.

Usually, the molecular weight M_{w} of the carboxyl-free polysiloxanes used according to the invention and having the structural elements I, II, optionally III a, III b and IV a is from 500 to 150 000, preferably up to 10 000, g/mol.

In a preferred embodiment of the present invention, carboxyl-containing and carboxyl-free polysiloxanes are chosen so that the molecular weight of the carboxyl-containing polysiloxane is higher than the molecular weight of the carboxyl-free polysiloxane.

The mixtures used according to the invention comprise, for example, from 10 to 90, preferably from 40 to 60, particularly preferably about 50, % by weight of carboxyl-free polysiloxane.

The formulations used according to the invention comprise one or more emulsifiers. For example, from 3 to 25, preferably from 5 to 20, particularly preferably from 8 to 18, % by weight, based on the formulation, of one or more emulsifiers are.

In principle, all compounds which are surface-active in aqueous systems and may be nonionic, anionic, cationic or zwitterionic can be used as emulsifiers.

Particularly suitable emulsifiers are N-acylated amino acid derivatives, for example of the formula V 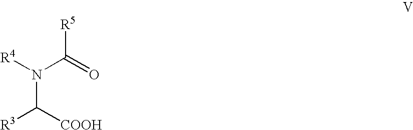
in which the variables are defined as follows:
R³ is hydrogen,
   C₁-C₄-alkyl, such as methyl, ethyl, n-propyl, isopropyl, n-butyl, isobutyl, sec-butyl and tert-butyl, in particular methyl;
   C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl;
R⁴ is C₁-C₄-alkyl, such as methyl, ethyl, n-propyl, isopropyl, n-butyl, isobutyl, sec-butyl and tert-butyl; in particular methyl;

The group CO—R⁵ is usually derived from saturated or unsaturated fatty acids. Saturated fatty acids are to be understood as meaning carboxylic acids which have C₉-C₂₀-alkyl and may be linear or branched, substituted or unsubstituted. R⁵ may be, for example, n-nonyl, n-decyl, n-dodecyl, n-tetradecyl, n-pentadecyl, n-octadecyl or n-eicosyl.

CO—R⁵ may be derived from an unsaturated fatty acid of 9 to 20 carbon atoms and one having up to 5° C.—C double bonds, it being possible for the C—C double bonds to be, for example, isolated or allylic, for example the acyl radical of linoleic acid, of linolenic acid and very particularly preferably of oleic acid.

In an embodiment of the present invention, all or at least a certain proportion, for example a third or a half, of the carboxyl groups are neutralized in N-acylated amino acid derivatives used as emulsifiers. For example, basic salts such as hydroxides or carbonates of the alkali metals, for example, Na or K, are suitable for neutralization. Ammonia, alkylamines, such as methylamine, dimethylamine, trimethylamine, ethyl-amine, diethylamine, triethylamine and ethylenediamine, and particularly preferably alkanolamines, such as ethanolamine, diethanolamine, triethanolamine, N-methyl-ethanolamine, N-methyldiethanolamine or N-(n-butyl)diethanolamine, are furthermore suitable for the neutralization.

Typical examples of compounds of the formula V are N-oleylsarcosine, N-stearyl-sarcosine, N-lauroylsarcosine and N-isononanoylsarcosine and the respective ethanolammonium salts, diethanolammonium salts and N-methyldiethanolammonium salts.

In an embodiment of the present invention, sulfur-containing emulsifier is used.

Sulfur-containing emulsifiers which may be used are in principle all sulfur-containing compounds which are surface-active in aqueous systems and may be nonionic, anionic, cationic or zwitterionic.

Particularly suitable compounds are those of the formula VI 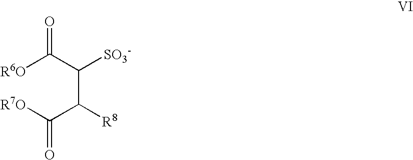
in which the variables are defined as follows:
R⁶ and R⁷ are identical or preferably different and are selected from hydrogen,
   C₁-C₃₀-alkyl, branched or straight-chain, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-undecyl, n-dodecyl, n-tridecyl, n-tetra-decyl, n-hexadecyl, n-octadecyl and n-eicosyl, preferably β-branched radicals of the formula VI a 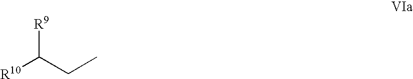
   (CH₂CH₂O)ₓ—O—R or [CH(CH₃)CH₂O)ₓ—O—R, where x is an integer in the range from 1 to 20,
   C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl;
R⁸ is selected from C₁-C₄-alkyl, such as methyl, ethyl, n-propyl, isopropyl, n-butyl, isobutyl, sec-butyl and tert-butyl
   and in particular hydrogen;
R⁹ and R¹⁰ are identical or preferably different and are selected from C₁-C₂₇-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-undecyl, n-dodecyl, n-tridecyl, n-tetradecyl, n-hexadecyl, n-octadecyl, n-eicosyl;
   the sum of the carbon atoms of R⁹ and R¹⁰ being not more than 30.
   R⁹ preferably has two carbon atoms more than R¹⁰; for example, the combinations
   R⁹=n-undecyl and R¹⁰=n-nonyl,
   R⁹=n-dodecyl and R¹⁰=n-decyl,
   R⁹=n-tridecyl and R¹⁰=n-undecyl,
   R⁹=n-tetradecyl and R¹⁰=n-dodecyl,
   R⁹=n-pentadecyl and R¹⁰=n-tridecyl,
   are preferred,
R¹¹ is selected from C₁-C₄-alkyl such as methyl, ethyl, n-propyl, isopropyl, n-butyl, isobutyl, sec-butyl, tert-butyl,
   phenyl, ortho-tolyl, meta-tolyl and para-tolyl
   and in particular hydrogen.

In a preferred embodiment of the present invention, exactly one of the radicals R⁶ and R⁷ is hydrogen and the other radical is selected from C₁-C₃₀-alkyl.

In a particularly preferred embodiment of the present invention, a mixture of a plurality of sulfur-containing compounds is chosen, for example of the formula VI, which may differ, for example, in that, in the first compound of the formula VI, R⁶ is hydrogen and R⁷ is selected from C₁-C₃₀-alkyl and, in the second one, R⁶ is hydrogen and R⁷ is selected from C₁-C₃₀-alkyl.

In an embodiment of the present invention, all or at least a certain proportion, for example a third or a half, of the sulfonyl groups in sulfur-containing compounds used as emulsifiers are neutralized. For example, basic salts, such as hydroxides or carbonates, of the alkali metals, such as, for example, Na or K, are suitable for the neutralization. Ammonia, alkylamines, such as, for example, methylamine, dimethyl-amine, trimethylamine, ethylamine, diethylamine, triethylamine or ethylenediamine, and very particularly alkanolamines, such as, for example, ethanolamine, diethanolamine, triethanolamine, N-methylethanolamine, N-methyldiethanolamine or N-(n-butyl)-diethanolamine, are furthermore suitable for the neutralization.

The preparation of compounds of the formula VI is known per se and is described in WO 01/68584. It is effected, for example, by mono- or diesterification of dicarboxylic anhydrides of the general formula VII 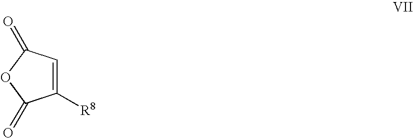
with corresponding alcohols, which need not be present in pure form, followed by a reaction with disulfite.

Instead of pure sulfur-containing compounds, for example sulfur-containing compounds of the formula V, it is possible to use mixtures of different sulfur-containing compounds. For example, it is possible to use, for the esterification, the mixture known as oxo oil 135 or oxo thick oil 135 (WO 01/68584).

In an embodiment of the present invention, formulations used in the process according to the invention may comprise up to 40% by weight, preferably up to 20% by weight, based on the formulation, of at least one alcohol of the formula VIII 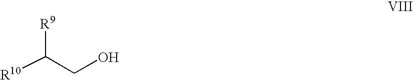
where, in formula VIII, the variables R⁹ and R¹⁰ are defined as above.

In an embodiment of the present invention, formulations used in the process according to the invention may comprise up to 50% by weight, preferably up to 30% by weight, based on the formulation, of at least one compound of the formula VIII.

In a preferred embodiment of the present invention, formulations used in the process according to the invention may comprise up to 40% by weight, particularly preferably up to 20% by weight, of mixtures which comprise at least one alcohol of the general formula VIII; oxo oil 135 and oxo oil 13 may be mentioned by way of example of such mixtures.

The formulation or the formulations used according to the invention is or are preferably aqueous.

In an embodiment of the present invention, at least one formulation used according to the invention comprises at least one further hydrophobic compound. At least one further hydrophobic compound is a carbon-based compound, for example natural or synthetic wax, natural or synthetic oil or natural or synthetic fat.

Examples of natural waxes are beeswax, cork wax, montan waxes and Carnauba wax.

Examples of synthetic waxes are polyethylene waxes or ethylene copolymer waxes, as obtainable, for example, by free radical polymerization of ethylene or free radical copolymerization of ethylene with, for example, (meth)acrylic acid or by Ziegler-Natta catalysis. Polyisobutylene waxes may furthermore be mentioned. Paraffin mixtures may also be mentioned; these are to be understood as meaning mixtures of hydrocarbons which have 12 or more carbon atoms and usually have a melting point of from 25 to 45° C. Such paraffin mixtures can be obtained, for example, in refineries or crackers and are known to a person skilled in the art as paraffin slack wax and sasol waxes. Montan ester waxes are a further example of synthetic waxes.

Examples of natural oils are triglycerides which are liquid at room temperature, for example fish oil, neatsfoot oil, olive oil, cotton seed oil, castor oil, sunflower oil and peanut oil.

Examples of synthetic oils are white oil, liquid paraffin, functionalized paraffins, such as chlorinated or sulfochlorinated paraffins, and polyalkylene glycols, such as polyethylene glycol.

Examples of natural fats are natural triglycerides which are solid at room temperature, such as lanolin, shellac wax and mixtures thereof.

In a preferred embodiment of the present invention, the further hydrophobic compound is at least one natural triglyceride.

In a further preferred embodiment, a combination of at least one natural triglyceride which is solid or liquid at room temperature and a paraffin mixture having a melting point of from 25 to 40° C. is used. The ratio is not critical per se, and weight ratios of natural triglyceride to paraffin mixture of from 10:1 to 1:10 are suitable.

According to the invention, from about 10 to 70, preferably from 20 to 40, % by weight, based on the formulation, of one or more further hydrophobic compounds can be used.

For carrying out the novel process, leather or fur skin is treated in a liquor, before, during or after the retanning, with the formulations used according to the invention. The novel treatment can be carried out once or repeatedly. The leathers to be treated may have been produced by any desired method, for example by mineral tanning, in particular chrome tanning, or by polymer tanning, tanning with syntans, resin tanning, tanning with vegetable tanning agents or tanning with combinations of the abovementioned tanning agents.

In an embodiment of the novel process, at least one novel formulation is added in one or more portions to the leather to be treated or to the skins to be treated. This addition can be effected in an aqueous liquor. Preferably, the liquor length may be from 50 to 2 000, preferably from 100 to 400, % by weight, based on the shaved weight of the leathers or the wet weight of the fur skin.

In an embodiment of the novel process, the components carboxyl-containing polysiloxane, carboxyl-free polysiloxane and emulsifier are added separately to the leather and/or leather and liquor and the novel formulation is prepared in situ.

The novel process is carried out in general by drumming the leather to be treated or the fur skin to be treated in suitable vessels, for example in barrels, in particular in rotatable barrels having internals. Other methods known to a person skilled in the art are also possible for thorough mixing.

Temperatures of from 20 to 65° C., preferably from 30 to 60° C., can be chosen as the temperature for the novel process.

The pressure conditions of the novel process are in general not critical. Atmospheric pressure (1 atm) is preferably employed, but it is also possible to employ reduced pressure, for example from 0.5 to 0.99 atm, or superatmospheric pressure, for example from 1.01 to 2 atm.

A pH of from 4 to 8, preferably from 4.5 to 8, can be established as the pH at the beginning of the novel treatment. At the end of the novel treatment, the pH can be reduced by adding an acid, for example formic acid, to a pH of from 3 to 5.

The novel treatment is generally complete after a time of from 20 minutes to 24 hours, preferably from 30 minutes to 12 hours. If the treatment is carried out repeatedly, the term novel treatment steps is used in the context of the present invention.

The amount of the formulation used according to the invention may be from 0.1 to 20, in particular from 0.5 to 15, % by weight, based on the shaved weight of the leathers to be treated or the wet weight of the skins to be treated.

During the novel treatment, conventional leather dyes can be added to the liquor. Suitable examples are acidic, substantive or basic aniline dyes, which can be used in amounts customary in tanning.

If it is desired to carry out the novel treatment during the retanning, any desired tanning agents customary in the tannery can, for example mineral tanning agents, in particular chrome tanning agents, or polymer tanning agents, syntans, resin tanning agents, vegetable tanning agents or combinations of the abovementioned tanning agents.

During the novel treatment, organic solvents, for example alcohols, can be added. However, the procedure is preferably carried out without addition of organic solvents.

The novel treatment can be supplemented by an aftertreatment with tanning agents customary in the tannery, for example mineral tanning agents, in particular chrome tanning agents, or with polymer tanning agents, syntans, resin tanning agents, vegetable tanning agents or combinations of the abovementioned tanning agents.

After the novel treatment, the leathers obtained or fur skins obtained according to the invention can be worked up in the manner customary in tanning.

The present invention furthermore relates to leathers produced by the novel process. Said leathers have very good performance characteristics, for example very good water repellency, very good handle and outstandingly level dyeing.

The present invention furthermore relates to the use of the novel leathers for the production of articles of clothing, for example jackets, coats, shoes and in particular boots. The present invention furthermore relates to the use of the novel leather for the production of pieces of furniture and furniture parts, for example leather sofas, leather armchairs, arm rests for chairs, arm chairs or sofas or benches. The present invention furthermore relates to the use of the novel leathers for the production of automotive parts, for example automobile seats, parts of dashboards and interior trim parts, for example in car doors.

The present invention furthermore relates to fur skins treated by the novel process.

The present invention furthermore relates to formulations comprising

from 1 to 20% by weight, based on the formulation, of a mixture of polysiloxanes, comprising

from 10 to 90% by weight, based on the mixture, of one or more carboxyl-containing polysiloxanes,

from 90 to 10% by weight, based on the mixture, of one or more carboxyl-free polysiloxanes,

and from 3 to 25, preferably from 5 to 20, particularly preferably from 8 to 18, % by weight, based on the formulation, of at least one emulsifier.

In an embodiment of the present invention, the novel formulations are formulations wherein the carboxyl-containing polysiloxanes are those polysiloxanes which comprise the structural elements of the formulae I, II and optionally III a and III b.

The structural elements of the formulae I, II, III a and III b are defined as above.

The carboxyl-containing polysiloxanes comprised in the novel formulations may furthermore comprise structural elements of the formulae IV a and IV b.

In an embodiment of the present invention, the carboxyl-free polysiloxanes comprised in the novel formulations are those polysiloxanes which generally comprise structural elements of the above-defined formulae I and optionally III a, III b and IV a, the variables being defined as above. Preferred carboxyl-free polysiloxanes comprised in the novel formulation are composed of structural elements of the above-defined formulae I comprise and optionally III a, III b and/or IV a.

In principle, all compounds which are surface-active in aqueous systems and may be nonionic, anionic, cationic or zwitterionic may be mentioned as emulsifiers in the novel formulations.

Particularly suitable emulsifiers are N-acylated amino acid derivatives, for example of the formula V, in which the variables are defined as above.

Other suitable emulsifiers are sulfur-containing emulsifiers.

In principle, all sulfur-containing compounds which are surface-active in aqueous systems and may be nonionic, anionic, cationic or zwitterionic may be mentioned as sulfur-containing emulsifiers in the formulations according to the invention.

Particularly suitable emulsifiers are sulfur-containing compounds, for example of the formula VI, in which the variables are defined as above.

In an embodiment of the present invention, the novel formulations are those formulations which comprise from 10 to 70% by weight, based on the formulation, of at least one further hydrophobic compound.

In an embodiment of the present invention, further hydrophobic compounds are a combination of at least one natural triglyceride which is solid or liquid at room temperature and a paraffin mixture.

The novel formulations may have a pH of 7 or more. Preferably, they have a pH of from 7 to not more than 10.

The novel formulations can preferably be aqueous formulations having a solids content of up to 50% by weight, based on the total formulation.

The novel formulations have a very good shelf life. Moreover, the novel formulations are excellent for use in the novel process.

The present invention furthermore relates to a process for the preparation of the novel formulations, also referred to below as novel preparation process. The novel preparation process can be carried out in general by mixing together the components carboxyl-free polysiloxane, carboxyl-containing polysiloxane and one or more emulsifiers and, if required, a hydrophobic compound or hydrophobic compounds. The sequence of the addition of the individual components is not critical. This can be effected, for example, by simple stirring of the components, for example using a mixer or an Ultra-Turrax stirrer. In some cases, further homogenization is effected, for example by means of a slot homogenizer. Novel formulations having a particularly good shelf life are obtained if further homogenization is carried out.

The examples which follow illustrate the invention.
1. Preparation of novel formulations 1.1 to 1.4 from carboxyl-containing polysiloxane, carboxyl-free polysiloxane, emulsifier and hydrophobic substances

The components mentioned below and shown in table 1 were stirred in a beaker at room temperature.

Carboxyl-containing polysiloxane PS 1: all R¹ are CH₃, A¹ is —(CH₂)₁₀— and Z¹ is a single bond, kinematic viscosity ν 500-850 mm²/s, determined at room temperature, molecular weight Mₙ: 10 000 g/mol, on statistical average 127 structural elements I and 2 or 3 structural elements II per molecule, structural elements II are randomly distributed.

Carboxyl-free polysiloxane PS 2: all R¹ are CH₃, kinematic viscosity ν 350 mm²/s, determined at room temperature, molecular weight Mₙ: 7 500 g/mol.

Emulsifier: N-oleylsarcosine as sodium salt, commercially available from BASF Aktiengesellschaft.

Natural triglyceride: lipoderm oil, a neatsfoot oil.

Synthetic oil: 36/38 paraffin slack wax, commercially available from Shell and from TotalFina.

The novel formulations 1.1 to 1.4 and, for comparative experiments, the formulations V 1.5 and V 1.6 were prepared. The composition of the formulations is shown in table 1.

For quality control of the emulsions thus obtained, 10 ml were taken and made up to 100 ml with water. Emulsions having a good shelf life formed overnight.

TABLE 1

| Component | 1.1 | 1.2 | 1.3 | 1.4 | V 1.5 | V 1.6 |
|---|---|---|---|---|---|---|
| PS 1 [g] | 5.0 | 5.0 | 5.0 | 5.0 | 10.0 | — |
| PS 2 [g] | 10.0 | 5.0 | 5.0 | 5.0 | — | 10.0 |
| N-Oleylsarcosine [g] | 12.9 | 10.0 | 10.0 | 17.0 | 12.9 | 10.0 |
| Triglyceride [g] | 15.3 | 15.0 | 10.0 | 13.0 | 12.5 | 17.0 |
| NaOH [g] | 1.5 | 1.3 | 1.2 | 2.0 | 1.5 | 1.5 |
| Paraffin slack wax [g] | 15.3 | 15.0 | 18.8 | 8.0 | 15.3 | 13.0 |
| Water [ml] | 45.0 | 51.3 | 50.0 | 50.0 | 50.0 | 50.0 |
| pH | 8.5 | 8.5 | 8.0 | 9.0 | 8.5 | 8.5 |

### EXAMPLE 2

### Treatment of Leather

### EXAMPLE 2.1

### Treatment of Leather with the Novel Formulations 1.1

The following general method was employed.

The data in % by weight are based in each case on the shaved weight, unless stated otherwise. In all operations, the barrel was rotated about 10 times per minute, unless stated otherwise.

In a rotatable 50 I barrel having internals, 100% by weight of water, 3% by weight of sodium formate and 1% by weight of MgO were added to 2.5 kg of chrome-tanned cattle leather (wet blue) having a shaved thickness of 2.5 mm. After 15 minutes, 0.6% by weight of NaHCO₃ was added and deacidification was effected at 35° C. over a period of 150 minutes so that a pH of 4.8 resulted.

3% by weight of the following substance having the following characteristic data were then added to the leather:

30% strength by weight aqueous polymer solution partly neutralized with NaOH; homopolymer of methacrylic acid, Mₙ of about 10 000; Fikentscher K value: 12, viscosity of the 30% strength by weight solution: 65 mPa·s (DIN EN ISO 3219, 23° C.), pH 5.1.

Stirring was carried out for a further 30 minutes.

In the first treatment step, 2% by weight of formulation 1.1 was added and drumming was carried out for a further 30 minutes. 3% by weight of the vegetable tanning agent mimosa extract and 2% by weight of the leather dye Luganil® Black NT, commercially available from BASF Aktiengesellschaft, were then added in the course of 10 minutes. Moreover, 2% by weight of the resin tanning agent Relugan® D, commercially available from BASF Aktiengesellschaft, 3% by weight of the vegetable tanning agent Chestnut® and 3% by weight of the syntan Basyntan SL®, commercially available from BASF Aktiengesellschaft, were added. The treatment was continued over a period of one hour.

In the second treatment step, a further 7.5% by weight of formulation 1.1 were added and drumming was continued at a pH of 4.7 for 12 hours.

100% by weight of water at about 70° C. were then added so that a temperature of 50° C. resulted, and a pH of 3.6 was established by adding formic acid a little at a time over a period of 80 minutes.

The liquor was discharged and the leather was washed with twice 200% by weight of water at 40° C. 100% by weight of water was then added to the top and the top dye was carried out at 40° C. with a mixture of 0.2% by weight of Leather Black VM and 0.3% by weight of the leather dye Luganil® Black AS, commercially available from BASF Aktiengesellschaft, and 0.2% by weight of formic acid at a pH of 3.6. Thereafter, the liquor was discharged, 100% by weight of water was added and treatment was effected with 3% by weight of chromium(III) sulfate at a pH of 3.5.

Finally, washing was carried out twice with water, drying was effected and working up was effected in a manner customary in tanning. The novel leather 3.1 was obtained.

The properties of the leathers obtained are shown in table 2.

### EXAMPLE 2.2

Example 1 was repeated except that formulation 1.2 was used in each case instead of 1.1 in the first and in the second treatment step. The novel leather 3.2 was obtained.

### EXAMPLE 2.3

Example 1 was repeated except that formulation 1.3 was used in each case instead of 1.1 in the first and in the second treatment step. The novel leather 3.3 was obtained.

### EXAMPLE 2.4

Example 1 was repeated except that formulation 1.4 was used in each case instead of 1.1 in the first and in the second treatment step. The novel leather 3.4 was obtained.

### COMPARATIVE EXAMPLE V 2.5

Example 1 was repeated except that formulation 1.5 was used in each case instead of 1.1 in the first and in the second treatment step. The comparative leather sample V 3.5 was obtained.

### COMPARATIVE EXAMPLE V 2.6

Example 1 was repeated except that formulation 1.6 was used in each case instead of 1.1 in the first and in the second treatment step. The comparative leather sample V 3.6 was obtained.

TABLE 2
Properties of the novel leathers and of the leathers obtained in the
comparative experiments

| | | | | | | |
|---|---|---|---|---|---|---|
| Leather or | 3.1 | 3.2 | 3.3 | 3.4 | V 3.5 | V 3.6 |
| comparative | | | | | | |
| leather sample | | | | | | |
| Maeser test | 18 000 | 15 000 | 15 000 | 15 000 | 7 600 | 400 |
| | 26 000 | 12 000 | 17 000 | 18 000 | 8 700 | 700 |
| Static water | 18 | 20 | 19 | 22 | 21 | 27 |
| absorption after | | | | | | |
| 2 hours | | | | | | |
| Dyeing | 3 | 3.5 | 3.5 | 5.5 | 4 | 4 |
| | | | | | (shadow) | (shadow) |

The Maeser measurements were carried out using a Maeser tester according to ASTM D 2099, in each case as double determinations. The static water absorption was carried out at 15% compression and stated in % by weight, based on the finished leather. The dyeing was assessed by visual inspection by a team of testers. The evaluations were effected using ratings: 1 (very good) to 6 (inadequate).
4. Preparation of Sulfur-Containing Emulsifiers
4.1. Preparation of the Sulfur-Containing E 4.1

115 g (0.3 mol) of the branched alcohol of the formula VIII. 1 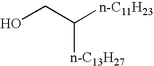
were initially taken, in the absence of moisture, in a 1000 ml three-necked flask equipped with stirrer, internal thermometer and reflux condenser and were heated to 100° C. in an oil bath. 29.4 g (0.3 mol) of maleic anhydride were then introduced with stirring, and the mixture thus obtainable was stirred for 5 hours at 100° C.

The monoester thus obtainable was cooled to 40° C. and stirred into 210 ml of water and partially neutralized by adding 17 g (0.21 mol) of 50% by weight aqueous NaOH, and the mixture obtained was heated to 80° C. Thereafter, 28.5 g of sodium disulfite were added with stirring, and the mixture was further stirred over a period of 6 hours at 80° C. Cooling to 40° C. was then effected.

4.2. Preparation of the Sulfur-Containing Emulsifier E 4.2

The procedure was as above but, instead of 115 gof the branched alcohol VIII. 1., 148.9 g (0.3 equivalent, calculated from the OH number) of oxo thick oil 135 were used.
5. Preparation of Formulation 5.1 According to the Invention using Carboxyl-Containing Polysiloxane, Carboxyl-Free Polysiloxane, Sulfur-Containing Sulfur-Containing Emulsifier E 4.1 and Hydrophobic Substances

The components according to Table 1 which are mentioned below were stirred in a beaker at room temperature using a mixer.

Carboxyl-containing polysiloxane “PS 1”: all R¹═CH₃, A¹: —(CH₂)₁₀—, Z¹: single bond, kinematic viscosity ν in the range 500-850 mm²/s, determined at room temperature, molecular weight Mₙ: 10 000 g/mol, on statistical average 127 structural element I and 2 or 3 structural elements II per molecule, structural elements II randomly distributed.

Carboxyl-free polysiloxane “PS 2”: all R¹═CH₃, kinematic viscosity ν of 350 mm²/s, determined at room temperature, molecular weight Mₙ: 7500 g/mol.

Emulsifier E 4.1.

Natural triglyceride: lipoderm oil, a neatsfoot oil.

Synthetic oil: slack wax 36/38, commercially available from Shell and from Total-Fina.

The mixture thus obtainable was then homogenized with the aid of an SHL 105 gap homogenizer from Brau and Luebbe, a pressure of 150 bar and a temperature of 50° C. being chosen.

Formulation 5.1 according to the invention was obtained.

An analogous procedure was adopted for the preparation of formulations 5.2 and 5.3 according to the invention and of comparative formulations V 5.4 and V 5.5 except that in each case compositions according to Table 3 were chosen. The composition of the formulations is shown in Table 3.

For quality control of the emulsions thus obtained, in each case 10 ml were taken and made to 100 ml with water. Emulsions which were storage-stable overnight resulted.

TABLE 3

| | Formulation | | | | |
|---|---|---|---|---|---|
| | 5.1 | 5.2 | 5.3 | V 5.4 | V 5.5 |
| PS 1 [g] | 1.0 | 2.0 | 0.5 | — | 4.0 |
| PS 2 [g] | 3.0 | 2.0 | 3.5 | 4.0 | — |
| Sulfur-containing emulsifier E 4.1 [g] | 25 | 25 | 25 | 25 | 25 |
| Oxo oil 135 [g] | 17 | 17 | 17 | 17 | 17 |
| White oil [g] | 11.5 | 11.5 | 11.5 | 11.5 | 11.5 |
| Demineralized water [ml] | 42.5 | 42.5 | 42.5 | 42.5 | 42.5 |
| pH | 8.5 | 8.5 | 8.5 | 8.5 | 8.5 |

For example 5.6, example 5.1 was repeated, but with 25 g of sulfur-containing emulsifier E 4.2 instead of E 4.1.

### EXAMPLE 6

### Treatment of Leather

### EXAMPLE 6.1

### Treatment of Leather with Formulation 5.1 According to the Invention

The following general recipe was followed.

The data in % by weight are based in each case on the shaved weight, unless stated otherwise. In all operations, the barrel was rotated 10 times per minute, unless stated otherwise.

In a rotatable 50 I barrel having internals, 100% by weight of water, 3% by weight of sodium formate and 1% by weight of MgO were added to 2.5 kg of chrome-tanned cattle leather (wet blue) having a shaved thickness of 2.5 mm. After 15 minutes, 0.6% by weight of NaHCO₃ was added and deacidification was effected at 35° C. over a period of 150 minutes so that a pH of 4.8 resulted.

3% by weight of polymer having the following characteristic data were then added: 30% strength by weight aqueous polymer solution partially neutralized with NaOH; homopolymer of methacrylic acid, Mn about 10 000, Fikentscher K value: 12, viscosity of 30% strength by weight solution: 65 mPa·s (DIN EN ISO 3219, 23° C.), pH 5.1.

Tanning was carried out for a further 30 minutes.

In the first treatment step, 10% by weight of formulation 5.1 was added and drumming was carried out for a further 30 minutes. 3% by weight of the vegetable tanning agent mimosa extract and 2% by weight of the leather tanning agent Luganil® Black NT, commercially available from BASF Aktiengesellschaft, were then added in the course of 10 minutes. Moreover, 2% by weight of the resin tanning agent Relugan® D, commercially available from BASF Aktiengesellschaft, 3% by weight of the vegetable tanning agent Chestnut® and 3% by weight of the sulfone tanning agent from EP-B 0 459 168, example K1, were added. The treatment was continued over a period of one hour.

In the second treatment step a further 7.5% by weight of formulation 5.1 were added and drumming was continued at a pH of 4.7 for 12 hours.

100% by weight of water at about 70° C. were then added so that a temperature of 50° C. resulted, and a pH of 3.6 was established by adding formic acid a little at a time over a period of 80 minutes.

The liquor was discharged and the leather was washed twice with 200% by weight of water at 40° C. 100% by weight of water was then added to the top and the top dyeing was carried out at 40° C. with a mixture of 0.2% by weight of Leather Black VM and 0.3% by weight of the leather dye Luganil® Black AS, commercially available from BASF Aktiengesellschaft, and 0.2% by weight of formic acid at a pH of 3.6. Thereafter, the liquor was discharged, 100% by weight of water was added and treatment was effected with 3% by weight of chromium(III) sulfate at a pH of 3.5.

Finally, washing was carried out twice with water, drying was effected and working up was effected in a manner customary in tanning. The leather 6.1 according to the invention was obtained.

The properties of the leathers obtained are shown in Table 4.

Examples 6.2 and 6.5 and comparative examples V 6.3 and V 6.4

Example 6.1 was repeated, except that formulations 5.2 and 5.3, V 5.4 and 5.5 were used in each case instead of 5.1 in the first and in the second treatment step. Leathers 6.2 and 6.3 and comparative leather samples V 6.4 and V 6.5 were obtained.

TABLE 4
Properties of the leathers according to the invention and of the
comparative leather samples obtained in the comparative experiments

| | | | | | |
|---|---|---|---|---|---|
| Leather or comparative leather | 6.1 | 6.2 | 6.3 | V 6.4 | V 6.5 |
| sample | | | | | |
| Formulation used | 5.1 | 5.2 | 5.3 | V 5.4 | V 5.5 |
| Bally penetrometer, water penetration | 120 | 130 | 60 | 40 | 110 |
| after [min] | | | | | |
| Static water absorption after 6 hours | 29 | 28 | 30 | 34 | 30 |
| [% by weight] | 32 | 29 | 32 | 39 | 28 |
| Dyeing | 3 | 3.5 | 3 | 4 | 5 |

The Maeser measurements and the water absorption were carried out as above.

1. A process for imparting water repellency to leather and fur skins, comprising
treating the leather or the fur skins with at least one formulation comprising
from 1 to 30% by weight, based on the formulation, of a mixture comprising
from 10 to 90% by weight, based on the mixture, of at least one polysiloxane comprising a carboxyl group,
from 90 to 10% by weight, based on the mixture, of at least one carboxyl free polysiloxane, and
from 3 to 25% by weight, based on the formulation, of at least one emulsifier.

2. The process of claim 1, wherein the at least one polysiloxane comprising a carbonyl group further comprises the structural elements of the formulae I and II 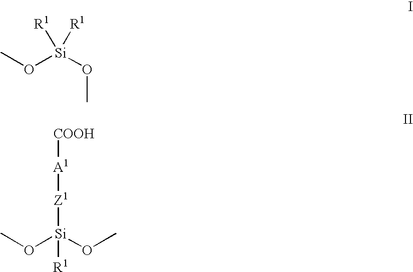
wherein
R¹ are identical or different and, independently of one another, are hydrogen, a hydroxyl, a C₁-C₄-alkyl, a C₆-C₁₄-aryl, a C₁-C₄-alkoxy, an amino, a mono-C₁-C₄-alkylamino, a di-C₁-C₄-alkylamino or a Z¹-A¹—COOH group;
A¹ are identical or different and are a linear or a branched C₅-C₂₅-alkylene; and
Z¹ is a direct bond, an oxygen, an amino, a carbonyl, an amido or an ester group.

3. The process of claim 1, wherein the at least one formulation comprises from 10 to 70% by weight, based on the formulation, of at least one further hydrophobic compound.

4. The process of claim 1, wherein the at least one emulsifier is an N-acylated amino acid.

5. The process of claim 1, wherein the at least one emulsifier comprises sulfur.

6. The process of claim 5, wherein the at least one emulsifier comprises at least one compound of the general formula VI 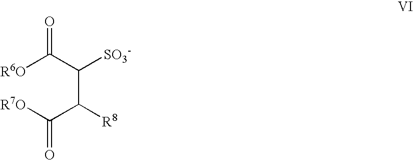
wherein
R⁶ and R⁷ are identical or different and are selected from the group consisting of hydrogen, a C₁-C₃₀-alkyl and a C₆-C₁₄-aryl group, and
R⁸ is a C₁-C₄-alkyl group or hydrogen.

7. The process of claim 3, wherein the at least one further hydrophobic compound comprises at least one natural triglyceride and a paraffin mixture.

8. The process of claim 1, wherein the treating is carried out at a pH of from 4 to 9.

9. The process of claim 1, wherein the treating is carried out at from 20 to 65° C.

10. A leather produced by the process of claim 1.

11. A method of producing an article of clothing, a piece of furniture, or an automotive part comprising incorporating the leather of claim 10 into the article of clothing, the piece of furniture, or the automotive part.

12. A fur skin produced by the method of claim 1.

13. A formulation comprising
from 1 to 20% by weight, based on the formulation, of a mixture comprising
from 10 to 90% by weight, based on the mixture, of at least one polysiloxane comprising a carboxyl group, from 90 to 10% by weight, based on the mixture, of at least one carboxyl-free polysiloxane, and
from 3 to 25% by weight, based on the formulation, of at least one emulsifier.

14. The formulation of claim 13, wherein the at least one polysiloxane comprising a carbonyl group further comprises structural elements of
the formulae I and II 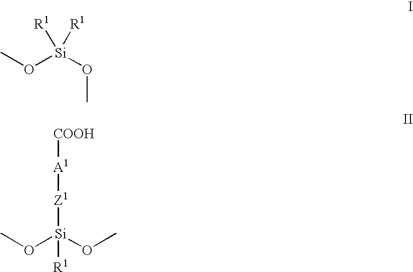
wherein
R¹ are identical or different and, independently of one another, are hydrogen, a hydroxyl, a C₁-C₄-alkyl, a C₆-C₁₄-aryl, a C₁-C₄-alkoxy, an amino, a mono-C₁-C₄-alkylamino, a di—C₁-C₄-alkylamino or a Z¹-A¹—COOH group;
A¹ are identical or different and are a linear or a branched C₅-C₂₅-alkylene; and
Z¹ is a direct bond, an oxygen, an amino, a carbonyl, an amido or an ester group.

15. The formulation of claim 13 further comprising from 10 to 70% by weight, based on the formulation, of at least one further hydrophobic compound.

16. The formulation of claim 15 wherein the at least one further hydrophobic compound comprises at least one natural triglyceride and a paraffin mixture.

17. A process for preparing the formulation of claim 13, comprising
mixing the at least one polysiloxane comprising a carboxyl group with the at least one carboxyl-free polysiloxane and the at least one emulsifier.

18. The process of claim 1, wherein the at least one polysiloxane comprising a carbonyl group further comprises the structural elements of the formulae III a and III b 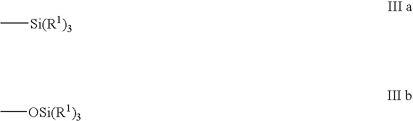
wherein
R¹ are identical or different and, independently of one another, are hydrogen, a hydroxyl, a C₁-C₄-alkyl, a C₆-C₁₄-aryl, a C₁-C₄-alkoxy, an amino, a mono-C₁-C₄-alkylamino, a di-C₁-C₄-alkylamino or a Z¹-A¹—COOH group;
A¹ are identical or different and are a linear or a branched C₅-C₂₅-alkylene; and
Z¹ is a direct bond, an oxygen, an amino, a carbonyl, an amido or an ester group.

19. The formulation of claim 13, wherein the at least one polysiloxane comprising a carbonyl group further comprises structural elements of the formulae III a and 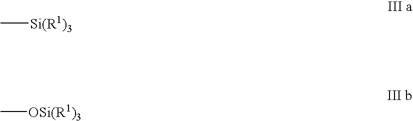
wherein
R¹ are identical or different and, independently of one another, are hydrogen, a hydroxyl, a C₁-C₄-alkyl, a C₆-C₁₄-aryl, a C₁-C₄-alkoxy, an amino, a mono-C₁-C₄-alkylamino, a di-C₁-C₄-alkylamino or a Z¹-A¹—COOH group;
A¹ are identical or different and are a linear or a branched C₅-C₂₅-alkylene; and
Z¹ is a direct bond, an oxygen, an amino, a carbonyl, an amido or an ester group.
